(19) United States
(12) Patent Application Publication
(10) Pub. No.: US 2009/0132269 A1
(43) Pub. Date: May 21, 2009

(54) Permit application and issuance system

(76) Inventor: James Perrill, Plymouth, MN (US)

Correspondence Address: MAIER & MAIER, PLLC, 1000 DUKE STREET, ALEXANDRIA, VA, 22314, US

(21) Appl. No.: 11/984,750

(22) Filed: Nov. 21, 2007

(51) Int. Cl. G06Q 99/00

(52) U.S. Cl. 705/1

(57) ABSTRACT

A method and system for issuing permits may include a computer network which may include a plurality of user computer access points. The access points may include an applicant access point accessible by an applicant for selecting a type of permit desired by an applicant, submitting project information relating to the government issued permit and submitting a completed permit application. The access points may also include an issuer access point accessible by an issuer for reviewing the completed permit applications. The method and system may also include a storage database, accessible through the applicant access point and the issuer access point, containing submitted information by the applicant and information disclosures the applicant is required to review prior to submitting an application for a permit.

### BACKGROUND

There are many construction and control issues involved in what happens on city street rights-of-way. The street right-of-way includes the street and areas on either side of the street used to support the use of the street. Street right-of-way also includes the areas below and above the roadway. The city has an interest in the rights-of-way either by ownership or through an easement for travel or utilities. The scope of the easement can be determined by a written easement document or by the use of the easement by the public. Private utilities can also use the public rights-of-way through a franchise or permit issued by the city.

A permit system requires a contractor or person who is excavating or causing an obstruction to obtain a permit for each site. The permit designates time and location for the work. The permit also places conditions on the work for public safety reasons and establish procedures for patching and restoration. Generally, reasonable fees are charged for registration and a permit. Registration requires a contractor working within the rights-of-way to submit specific identification information and insurance information. The city also requires the work site be made available for city inspections.

A permit system protects the right-of-way and increases coordination of users. The city is liable for the condition of its right-of-way, therefore, the permit system gives knowledge of what work is being done and where it is being done. Some common city permits that fall within the coverage of a right-of-way permit may include: road closures, obstructions, excavations, utilities, encroachment, street cut, driveway apron, sidewalk and sewer permits.

Filing a right-of-way permit requires requesting a permit application by mail, filling out the appropriate information and returning the application, either by mail or in person, and then waiting for approval. Approval of a permit can take several weeks or months to process and issue.

### SUMMARY

An exemplary embodiment may disclose a computer implemented method for issuing permits which may include providing a computer network including a plurality of user computer access points. The access points may include an applicant access point accessible by an applicant and an issuer access point accessible by an issuer. The computer implemented method may also provide a storage database containing information submitted by the applicant and information disclosures the applicant is required to review prior to submitting an application for a permit. Additionally, the computer implemented method may include selecting a type of permit desired by an applicant, through the applicant access point, and submitting project information relating to the permit and a completed permit application, through the applicant access point. The computer implemented method may also include reviewing the completed permit application and sending a response to the applicant that may inform the applicant of an outcome of the review of the completed permit application, through the issuer access point.

Another exemplary embodiment can disclose a computer system for issuing permits that may include a computer network having a plurality of user computer access points. The access points may include an applicant access point accessible by an applicant for selecting a type of permit desired by an applicant, submitting project information relating to the government issued permit and submitting a completed permit application. The access points may also include an issuer access point accessible by an issuer for reviewing the completed permit applications. The computer system may also include a storage database, accessible through the applicant access point and the issuer access point, containing submitted information by the applicant.

A further exemplary embodiment may disclose a method for issuing permits which may include providing a computer network including a plurality of user computer access points. The access points may include an applicant access point accessible by an applicant and an issuer access point accessible by an issuer. The method may also provide a storage database containing information submitted by the applicant and information disclosures the applicant is required to review prior to submitting an application for a permit. Additionally, the method may include selecting a type of permit desired by an applicant, through the applicant access point and submitting project information relating to the permit and a completed permit application, through the applicant access point. Then the method may include reviewing the completed permit application and sending a response to the applicant informing the applicant of an outcome of the review of the completed permit application, through the issuer access point.

### BRIEF DESCRIPTION OF THE DRAWINGS

Advantages of embodiments of the present invention will be apparent from the following detailed description of the exemplary embodiments thereof, which description should be considered in conjunction with the accompanying drawings in which like numerals indicate like elements, in which:

FIG. 1 is a flow chart depicting an exemplary embodiment of a computer network for a permit application and issuance system.

FIG. 2a is a flow chart depicting an exemplary embodiment of an applicant access point for a permit application and issuance system.

FIG. 2b is a continuation of a flow chart depicting an exemplary embodiment of an applicant access point for a permit application and issuance system.

FIG. 2c is a further continuation of a flow chart depicting an exemplary embodiment of an applicant access point for a permit application and issuance system.

FIG. 3a is a flow chart depicting an exemplary embodiment of a network manager access point for a permit application and issuance system.

FIG. 3b is a continuation of a flow chart depicting an exemplary embodiment of a network manager access point for a permit application and issuance system.

FIG. 4 is a flow chart depicting an exemplary embodiment of an issuer access point for a permit application and issuance system.

### DETAILED DESCRIPTION

Aspects of the permit application and issuance system are disclosed in the following description and related drawings directed to specific embodiments of the permit application and issuance system. Alternate embodiments may be devised without departing from the spirit or the scope of the permit application and issuance system. Additionally, well-known elements of exemplary embodiments of the permit application and issuance system will not be described in detail or will be omitted so as not to obscure the relevant details of the permit application and issuance system. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the terms “embodiments of the permit application and issuance system,” or “exemplary embodiments,” do not require that all embodiments of the permit application and issuance system include the discussed feature, advantage or mode of operation.

A permit application and issuance system may provide permit applicants and city governments or other permit issuers the ability to file permit applications and send and receive responses, approvals and disapprovals over a computer network. The permit application and issuance system may be utilized to apply for and issue permits such as: right-of-way, road closure, obstruction, excavation, utility, encroachment, street cut, driveway apron, sidewalk, sewer and other permits that may require an application and an issuance process.

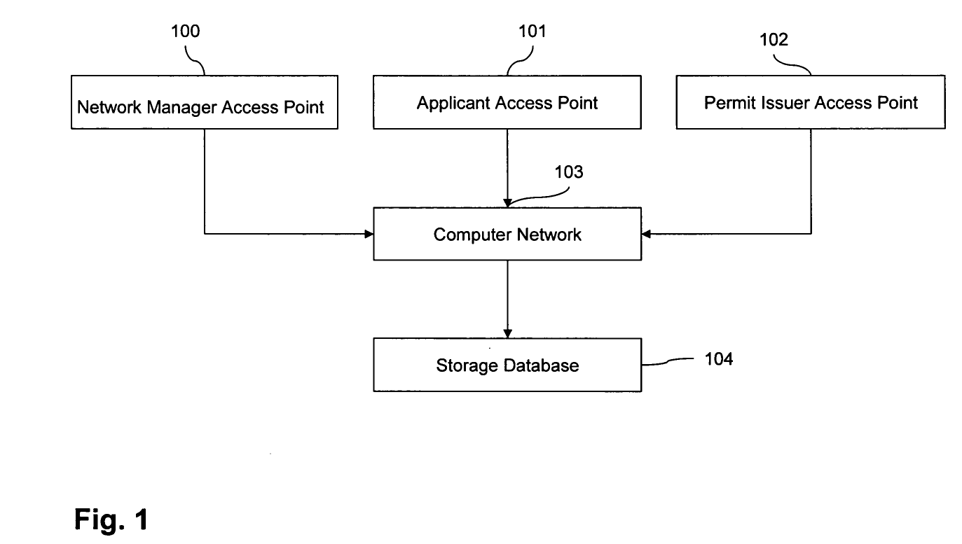

In an exemplary embodiment, as shown in FIG. 1, a permit application and issuance system may include a computer network 103, which may be a local hardwired network, an internet network or any other computer operable network. Computer network 103 may have a network manager access point 100, applicant access point 101, permit issuer access point 102 or any other desired access point capable of communicating on computer network 103. Each access point may be communicable with network 103 and may have access to a storage database 104.

Storage database 104 may store information submitted through an access point to computer network 103 and may enable a user to alter information previously stored on storage database 104. The memory of storage database 104 may vary in size and may be stored on any desired computer readable medium.

To access computer network 103 through an access port, a user may register a profile with a permit application and issuance system administrator. This registration may include the submission of identification information and the creation of a log-on identification and password. This registration information may also be accessible during the permit application process.

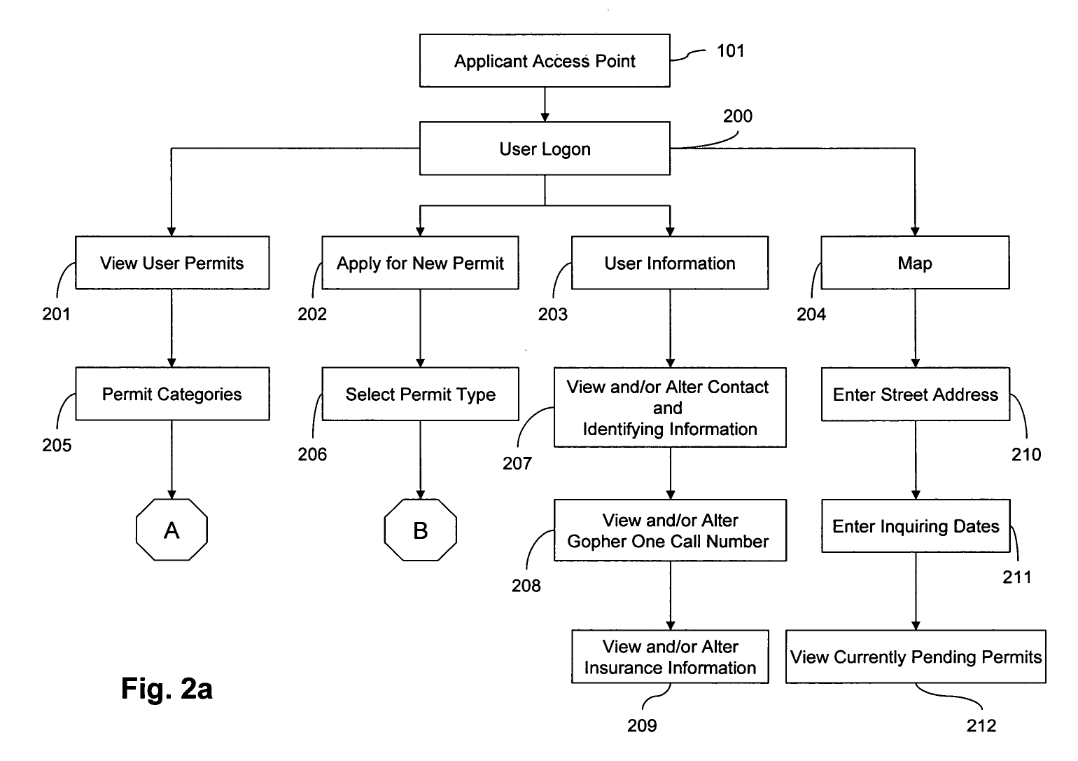

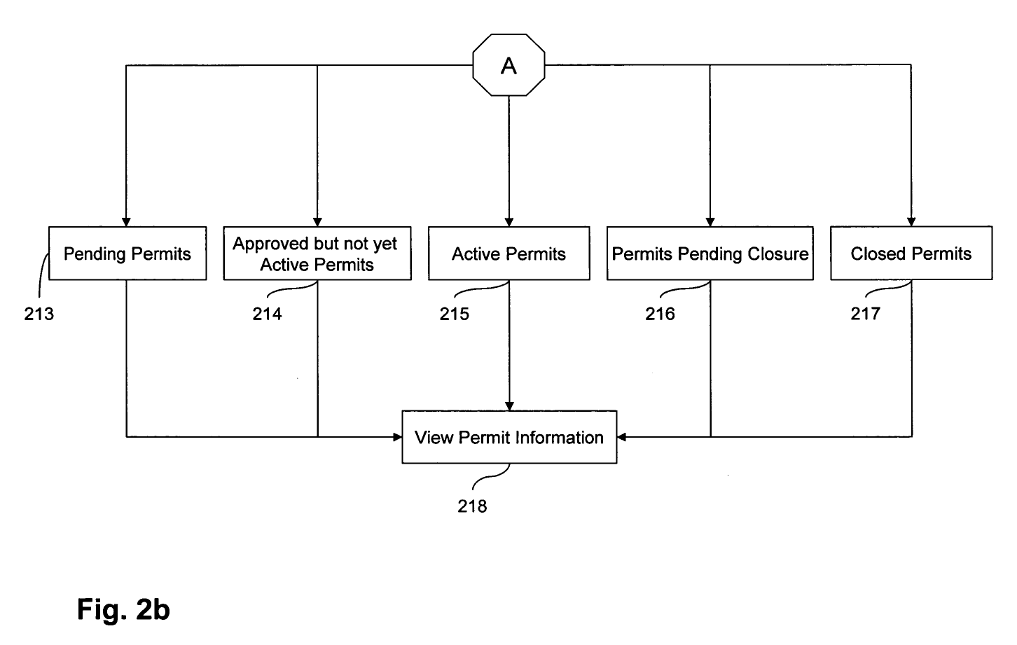

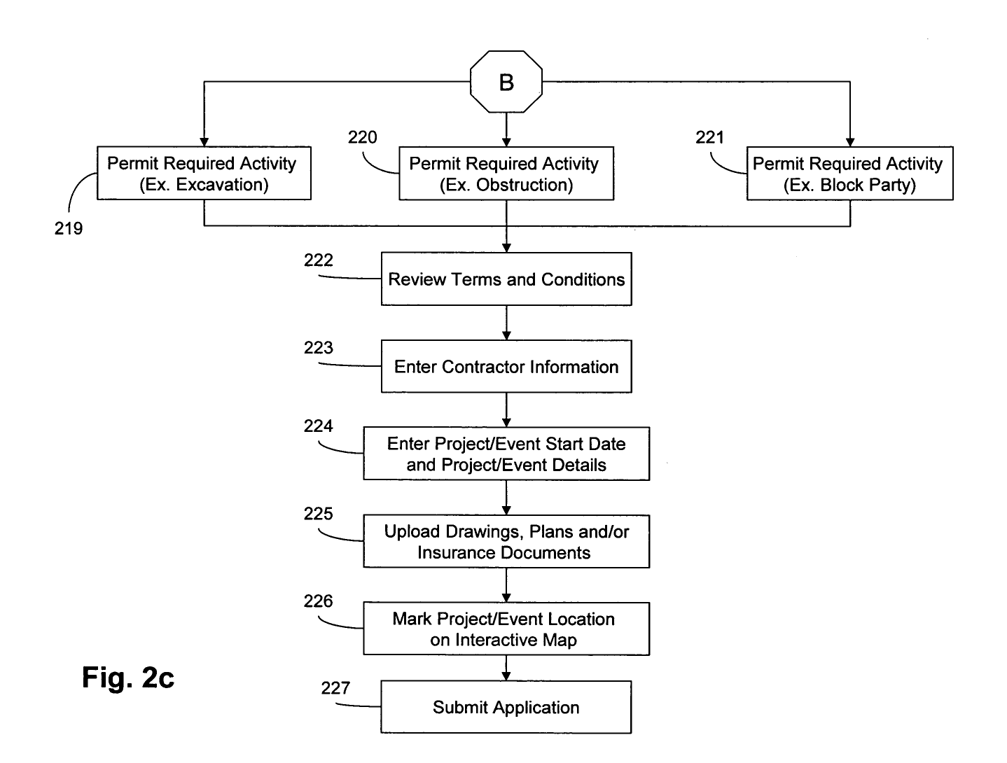

In an exemplary embodiment, as shown in FIGS. 1 and 2a-2c, an applicant user may access computer network 103 through applicant access port 101, accessible through a user logon 200. Once a user logs onto computer network 103, the user may select a category, for example, view user permits 201, apply for a new permit 202, user information 203, a map 204 or any other desired category.

If a user selects view user permits 201, the user may be directed to user permit categories 205. Permit categories 205 may be organized into separate folders, for example, pending permits 213, approved but not yet active permits 214, active permits 215, permits pending closure 216, closed permits 217 or any other desired permit category folder. Selecting any one of these permit folders may direct a user to a listing of corresponding permit information 218 that may have previously been submitted by the user and stored on storage data base 104. Permit information 218 may include, but is not limited to, an action identification number, the date an application was submitted, the begin date and end date of the permit, permit type, a project identification number or any other desired information with regards to a submitted permit.

If a user selects apply for a new permit 202, the user may be directed to an interactive permit application. This permit application may prompt a user to select a permit type 206. There may be any number of permit required activites, which may include, for example, excavation 219, obstruction 220 and block party 221 permits. Each permit type may prompt a user to review terms and conditions 222 related to obtaining a permit and the terms and conditions 222 of the permit itself. These terms and conditions 222 may be reviewed by the user and the user may submit an agreement or disagreement to those conditions.

Upon agreement to the terms and conditions 222, the user may be prompted to submit additional permit application information. The permit application information may include contractor information 223, for example, company name, primary contact, phone and fax number, e-mail address, street address and any other distinguishing contractor information. Additionally, the permit application information may include the location, which may be a written description of the physical location, of the project or event and the proposed start and end date of the project or event.

The location of the project or event may also be indicated on an interactive map 226. This map 226 may be a detailed map depicting streets, neighborhoods, business communities or other geographical features. The map 226 may also include indicators on the map 226 indicating permits that may be active and approved during the same time frame as entered by the user and may be in the same area or region as entered by the user. This may allow the user to visually see other permits that may affect the approval of the user's permit or provide the opportunity to consolidate activities with other permit holders.

This map 226 may include the capability to zoom, in or out, over different areas of the map showing added detail or a more general overview of a desired region. The map 226 may also have the capability of providing the user with a drawing tool that may be used to annotate the map 226 to indicate the proposed location of the user's project or event.

Permit application information may also include any documents or plans 225 that may be necessary to obtaining a permit. These documents or plans 225 may be submitted by the user electronically and stored on storage database 104. Additionally, permit application information that may be necessary for submission by the user may be specific to the type of permit being sought, for example, outlining project or event dates and details 224. For example, if a block party 221 permit is being sought, the user may be prompted by the permit application and issuance system to submit, event start and end times, number of expected participants, an emergency evacuation plan, alcohol license, liability insurance or any other information required by a block party 221 permit. Another example, if an obstruction 220 permit is being sought, the user may be prompted to submit, items that may be placed in the right-of-way, duration of the obstruction, traffic lane closures, insurance documentation and any other information required by an obstruction 220 permit. A final example, if an excavation 219 permit is being sought, the user may be prompted to submit, dimensions of the excavation, if the project is restoration work and any other information that may be required by an excavation 219 permit.

In another exemplary embodiment, the user may select user information 203 which may direct the user to a listing of contact and identifying information 207. This identifying information 207 may be submitted or altered and then stored on storage database 104, and may include a company name, primary contact, phone and fax number, e-mail address, street address and any other distinguishing user information. Additionally, a user may submit or alter a Gopher-One Call 208 registration certificate number, if required by state law. A user may also be prompted to submit or alter insurance information 209 or any other information that could potentially be used in gaining approval of a permit.

In another exemplary embodiment, map 204 may be selected. Upon selecting map 204, the user may be prompted to enter a desired street address 210 or location and inquiring dates 211. After submitting these pieces of information current permits 212, approved or pending, may be viewed on a map. These permits may be shown as markers on the map 204. The map 204 may include the capability to zoom, in or out, over different areas of the map 204, showing added detail or a more general overview of a desired region.

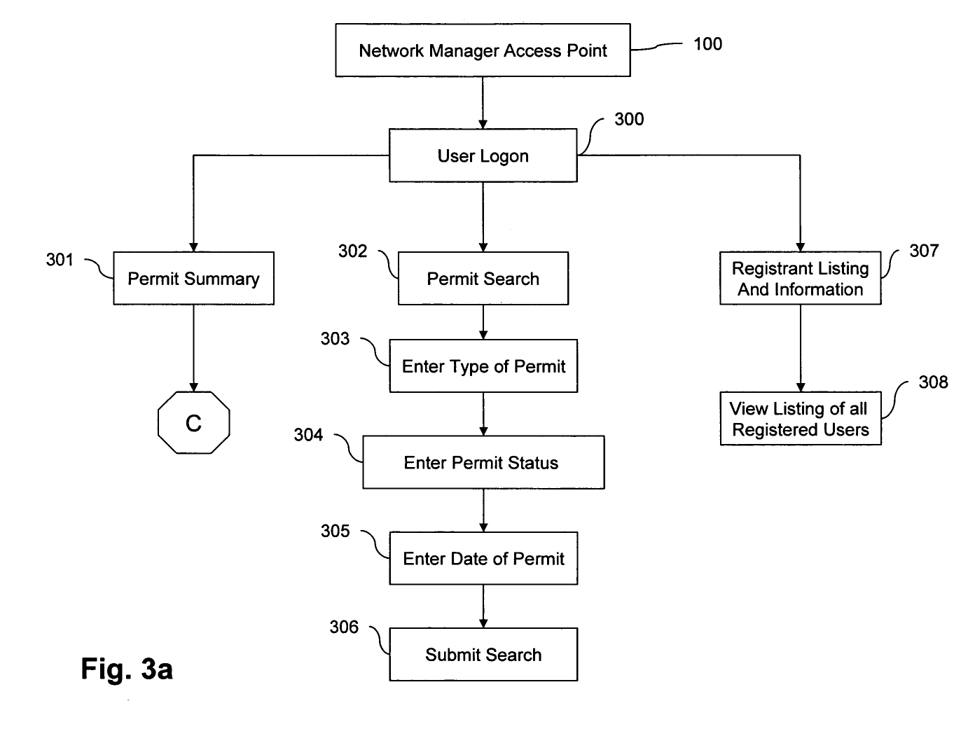

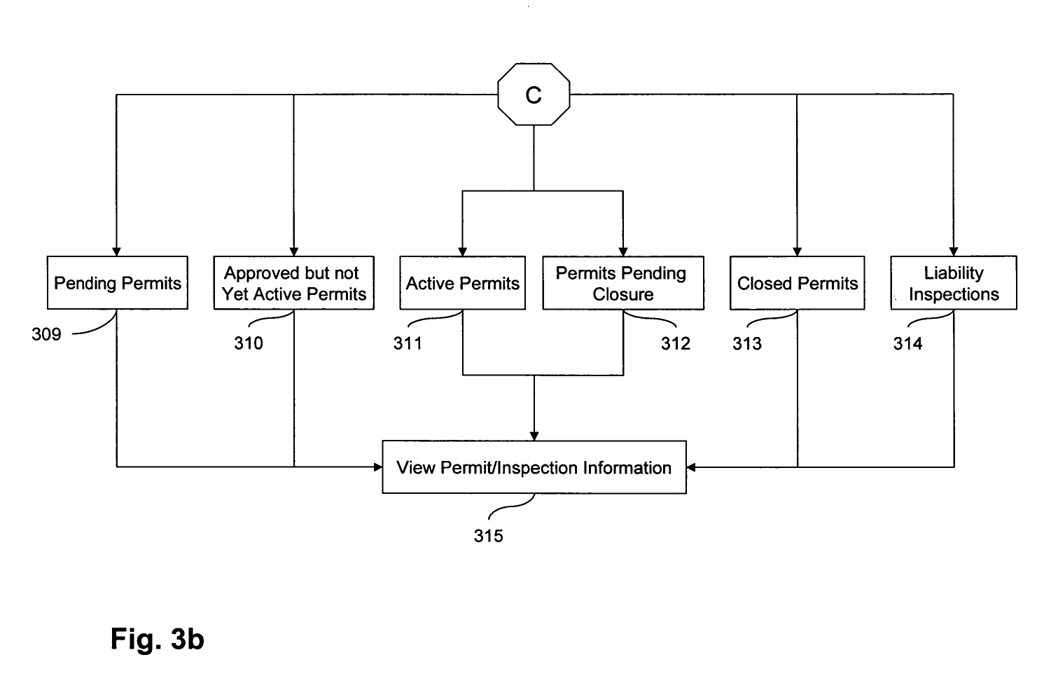

In a further exemplary embodiment, as shown in FIGS. 1, 3a and 3b, a user may access computer network 103 and storage database 104 through network manager access point 100. In order to initially gain access, a user may have to log onto 300 the permit application and issuance system. After logging onto the system the user may be prompted to select a category which may include, for example, a permit summary 301, a permit search 302, a registrant listing and information 307 and any other categories that may be related to the permit application and issuance system.

In an exemplary embodiment, a user may select permit summary 301, which may direct the user to another listing of categories or files, for example, pending permits 309, approved but not yet active permits 310, active permits 311, permits pending closure 312, closed permits 313, liability inspections 314 and any other desired categories or files that may be related to the permit application and issuance system.

Upon selecting one of these categories or files the user may be directed to a listing of corresponding permit or inspection information 315. Permit and inspection information 315 may include, but is not limited to, an action identification number, the date an application was submitted, the begin date and end date of the permit, permit type, a project identification number or any other desired information with regards to a submitted permit. These listings may provide a user with information that may aid in troubleshooting potential problems in the system, track the progress of permit applications and any other desired issue that may require permit and inspection information 315.

The user may also select permit search 302 which may prompt the user to enter a permit type 303, for example, excavation, obstruction, block party or any other permit type. The user may then be prompted to enter a permit status 304, for example, pending permits, approved but not yet active permits, active permits, permits pending closure, closed permits or any other desired per status. The user may then be prompted to enter a permit date 305, for example, calendar days. The user may also be prompted to enter any other distinguishing permit characteristics that may aid distinguishing a particular permit.

Upon entry of this information a user may submit a search 306. This may activate a search of permits and permit applications stored on storage database 104. The permit application and issuance system may then list permits and permit applications that include the previously submitted information. As the permits and permit applications are listed, the user may view the information relating to these permits and applications, for example, an action identification number, the date an application was submitted, the begin date and end date of the permit, permit type, a project identification number or any other desired information with regards to a submitted permit.

In another exemplary embodiment, the user may select registrant listing and information 307 which may direct the user to a listing of all or a selected portion of users registered 308 with the permit application and issuance system. This listing of registered users 308 may include identification information corresponding to each individual registrant and may include, for example, company name, primary contact, phone and fax number, e-mail address, street address and any other distinguishing registrant information.

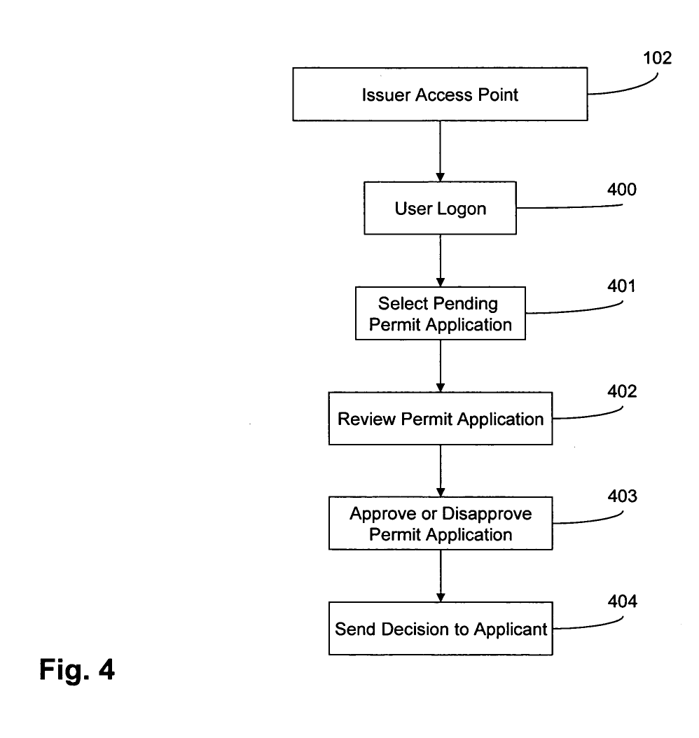

In a further exemplary embodiment, as shown in FIGS. 1 and 4, a user may access computer network 103 and storage database 104 through issuer access point 102. In order to initially gain access a user may have to log onto 400 the permit application and issuance system. After logging onto the system the user may view and select pending permit applications 401, which have been stored on storage database 104. Upon selecting a pending permit application the application may be reviewed 402.

The user may have access to all of the permit application 402 information submitted by an applicant. This permit application 402 information may include, but is not limited to, contractor information, for example, company name, primary contact, phone and fax number, e-mail address, street address and any other distinguishing contractor information. Additionally, the permit application 402 information may include the location, which may be a written description of the physical location, of the project of event and the proposed start and end date of the project or event. Thus, the user may have viewing access to all necessary information, plans, figures and documents necessary to approve or disapprove a permit application 403.

After approving, approve pending or disapproving a pending permit application 403, the user, or issuer, may send the decision 404 directly to the applicant. This decision may be sent via email, phone, fax or any other desired transmission. Because the issuer and applicant may each have access to computer network 103 and storage database 104, the transfer of information between the two parties can be substantially instantaneous or only a matter of a few minutes, depending on the network connection and internet speed or other potentially contributing factors. Therefore, through the use of the permit application and issuance system, permit applicants can submit complete permit applications electronically without having to download application forms.

Issuers are likewise able to view permit applications electronically and send permit status notifications electronically as well. Users may also export permit and/or registrant data, for example, into a spreadsheet program or any other desired computer program. Additionally, a user may generate status reports, billing reports or any other desired reporting document, utilizing the information stored on storage data base 104. A user may also access a system setup through the issuer access point 102, where the user may change or view notification messages, legal disclosures, registrants and permit recipient information or any other information that may be stored on storage database 104.

Similar to the applicant access point 101 and the network access point 100, as previously described, a user may access a map showing pending and issued permits according to geographical location. These permits may be shown on the map according to a variety of different parameters, for example, the type of permit or the status of the permit. This system can drastically reduce time wasted obtaining documents, mailing documents and waiting for decisions.

The foregoing description and accompanying drawings illustrate the principles, preferred embodiments and modes of operation of the invention. However, the permit application and issuance system should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the permit application and issuance system as defined by the following claims.

What is claimed is:

1. A computer implemented method for issuing permits comprising:
providing a computer network including a plurality of user network access points, wherein the access points include:
an applicant access point accessible by an applicant; and
an issuer access point accessible by an issuer;
providing a storage database containing information submitted by the applicant;
selecting a type of permit desired by an applicant through the applicant access point;
submitting project information relating to the permit through the applicant access point;
submitting a completed permit application through the applicant access point;
reviewing the completed permit application through the issuer access point; and
sending a response to the applicant informing the applicant of an outcome of the review of the completed permit application.

2. The computer implemented method of claim 1 further comprising:
providing a network manager access point accessible by a network manager, for viewing contractor information that is submitted by the applicant.

3. The computer implemented method of claim 2, wherein the network manager can review pending and issued permits through the network manager access port.

4. The computer implemented method of claim 1, wherein submitting project information relating to permits further includes:
submitting contractor identification information;
submitting the desired date the permit is to be executed; and
submitting a description of a project requiring the permit.

5. The computer implemented method of claim 1, wherein submitting project information relating to the government issued permit further includes:
submitting an indication of a location of a project requiring the permit on a map, wherein the map is stored on the storage database.

6. The computer implemented method of claim 5, wherein the map displays locations of projects that have been issued government issued permits for a date that coincides with a date submitted by the applicant.

7. The computer implemented method of claim 1, wherein sending a response to the applicant informing the applicant of an outcome of the review of the completed permit application includes:
sending a notice of an approved or rejected permit via email transmission.

8. A computer system for issuing permits, comprising:
a computer network including a plurality of user network access points, wherein the access points include:
an applicant access point accessible by an applicant to select a type of permit desired by an applicant, submit project information relating to the permit by the applicant and submit a completed permit application;
an issuer access point accessible by an issuer to review the completed permit application; and
a storage database, accessible through the applicant access point and the issuer access point, containing submitted information by the applicant.

9. The computer system of claim 8, further comprising:
a network manager access point accessible by a network manager, to view contractor information that is submitted by the applicant.

10. The computer system of claim 9, wherein the network manager access point is used to review pending and issued permits.

11. The computer system of claim 8, wherein the applicant access point is used to submit contractor identification information, the desired date the permit is to be executed and a description of a project requiring the permit.

12. The computer system of claim 8, further comprising:
a map, wherein the map is stored on the storage database and is used to submit an indication, by the applicant, of a location of a project requiring the permit.

13. The computer system of claim 12, wherein the map displays locations of projects that have been issued permits for a date that coincides with a date submitted by the applicant.

14. The computer system of claim 8, wherein the issuer access point is used to send a notice of an approved or rejected government issued permit via email transmission.

15. A method for issuing permits comprising:
providing a computer network including a plurality of user network access points, wherein the access points include:
an applicant access point accessible by an applicant; and
an issuer access point accessible by an issuer;
providing a storage database containing information submitted by the applicant;
selecting a type of permit desired by an applicant through the applicant access point;
submitting project information relating to the permit through the applicant access point;
submitting a completed permit application through the applicant access point;
reviewing the completed permit application through the issuer access point; and
sending a response to the applicant informing the applicant of an outcome of the review of the completed permit application.

16. The method of claim 15 further comprising:
providing a network manager access point accessible by a network manager, for viewing contractor information that is submitted by the applicant.

17. The method of claim 16, wherein the network manager can review pending and issued permits through the network manager access port.

18. The method of claim 15, wherein submitting project information relating to permits further includes:
submitting contractor identification information;
submitting the desired date the permit is to be executed; and
submitting a description of a project requiring the permit.

19. The method of claim 15, wherein submitting project information relating to the government issued permit further includes:
submitting an indication of a location of a project requiring the permit on a map, wherein the map is stored on the storage database.

20. The method of claim 19, wherein the map displays locations of projects that have been issued government issued permits for a date that coincides with a date submitted by the applicant.
